(19) United States
(12) Patent Application Publication
(10) Pub. No.: US 2018/0308147 A1
(43) Pub. Date: Oct. 25, 2018

(54) Systems and Methods for Providing a Ranked Product or Service Listing for Products at a Convention

(71) Applicant: Thuon Chen, Oakland, CA (US)

(72) Inventor: Thuon Chen, Oakland, CA (US)

(21) Appl. No.: 15/959,010

(22) Filed: Apr. 20, 2018

Related U.S. Application Data
(60) Provisional application No. 62/488,508, filed on Apr. 21, 2017.

(51) Int. Cl. G06Q 30/06; G06Q 30/02; H04W 4/38; H04W 4/33; H04W 4/021

(52) U.S. Cl. CPC G06Q 30/0629; G06Q 30/0201; H04W 4/021; H04W 4/33; H04W 4/38

(57) ABSTRACT

Systems and methods are configured for for providing a ranked product or service listing for products or services at a convention, the convention including a plurality of exhibitor areas where the exhibitors display products or services. The systems and methods utilize a network and a computer device including a processor and a memory, the memory storing non-transitory machine-readable code to be executed by the processor to provide the ranked product or service listings to an attendee of the convention. A plurality of sensors are disposed adjacent to or within selected ones of the exhibitor areas, and the sensors are configured to gather sensor data relating to each of the products or services. The computer device is configured to generate the ranked product or service listings based on a number of touch points of the products or services determined by the computer device from the sensor data.

### FIELD OF THE INVENTION

Embodiments of the present invention relate to systems and methods for providing a ranked product or service listing for products or services at a convention.

### BACKGROUND OF THE INVENTION

Certain events, such as trade shows, conventions and exhibitions, may have large numbers of exhibitors each having a booth, floor space, suite, etc. to present their products and/or services to attendees of the event. Such events are often multi-day events with thousands of visitors or attendees. Some of these events have grown to enormous size and may include hundreds or even thousands of different exhibitors, each of which may have one or more than one booth, floor space, suite, etc. to present their products and/or services. For example, the 2017 Consumer Electronics Show (CES) had more than 4,000 exhibitors and 2.6 million square feet of exhibit space.

Such events may make it difficult for attendees to find items of interest at the event due to the large numbers of exhibitors. This is further exacerbated when the attendee is unsure of particular brand names of items that may be of interest, or simply wants to find items that are generating a lot of interest. While some events like CES provide some search capability, such as the ability to search by exhibitor name, product categories, brand names, and the like, there is no ability to search for products that are generating the most interest, products that are “hot.”

It would be advantageous if a method could be developed to overcome the above-described problems and provide the attendees of such conventions with the ability to not only search for particular products, but to have the search results generated based on which products are generating the most interest at the convention.

### SUMMARY OF THE INVENTION

In preferred embodiments of the invention, systems and methods are disclosed for providing a ranked product or service listing for products or services at a convention, the convention including a plurality of exhibitor areas where the exhibitors display products or services. The systems and methods utilize a network and a computer device including a processor and a memory, the memory storing non-transitory machine-readable code to be executed by the processor to provide the ranked product or service listings to an attendee of the convention. A plurality of sensors are disposed adjacent to or within selected ones of the exhibitor areas, and the sensors are configured to gather sensor data relating to each of the products or services. The computer device is configured to generate the ranked product or service listings based on a number of touch points of the products or services determined by the computer device from the sensor data.

Further objects, features, and advantages of the present invention over the prior art will become apparent from the detailed description of the drawings which follows, when considered with the attached figures.

### DESCRIPTION OF THE DRAWINGS

FIG. 1 illustrates a system for in accordance with embodiments of the invention;

FIG. 2 illustrates a flowchart of a method in accordance with embodiments of the invention;

FIG. 3 illustrates a flowchart of a method in accordance with embodiments of the invention; and

FIG. 4 is a drawing illustrating a method in accordance with embodiments of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The term “convention” is herein defined to mean a gathering at a location of a plurality of exhibitors of goods or services for display and/or sale to attendees. Included in this definition are trade shows (such as the Consumer Electronics Show, auto shows, etc.), exhibitions, expositions and other meetings where a plurality of exhibitors present products and/or services to attendees, as well as shopping malls with a plurality of stores at one location and casinos with a plurality of gaming machines for play by customers.

The term “touch point” is herein defined to mean an interest shown in a product or service as determined from analysis of sensor data captured by one or more sensors of the product or service. The touch point may be a person looking at the product or service, looking at the product or service for a predetermined period of time, touching the product or service, entering a booth or other defined area at the convention where the product or service is displayed, or a person coming within a predetermined distance of the product or service.

The systems and methods of the embodiments of the invention are configured to provide ranked product or service listings for products or services at a convention, the products and/or services being displayed in exhibitor areas for viewing by attendees of the convention. The ranked product or service listings are provided based on how much interest, or how many touch points of a product or service occur during the convention. Sensor data from at least one sensor disposed adjacent to or within selected ones of the exhibitor areas is gathered, the sensor data being data relating to each of the products or services. A computer device receives the sensor data and analyzes the sensor data to determine touch points, or how much interest, is shown in individual products or services. Ranked product or service listings are generated based on a number of touch points of the products or services determined by the computer device from the sensor data.

The amount of interest shown in each product or service can be determined by the computer device by analyzing the sensor data to determine how many times an interest is shown in a product or service. The more interest that is shown in a product or service, the higher the product or service will be ranked in the listing of products or services. This type of listing based on interest in products or services as determined by embodiments of the invention allows a display of the ranked products or services in an order of which products or services are having the most interest by persons attending the convention. The products with the highest level of interest, or touch points, will be higher ranked on the listing, providing a listing of “hot” products or services at the convention for display to attendees.

The systems and methods of the embodiments of the invention also can provide a weighting to the touch points according to the type of touch point determined for the product or service. For example, the types of touch points for the product or service may include a person physically touching the product or service, a person entering an exhibitor area where the product or service is displayed, a person looking at the product or service, a person looking at the product or service for a certain length of time, a person being within a certain distance of the product or service, and so forth.

The weighting could be applied to the touchpoints in any desired manner. One possible weighting could weight the type of touchpoints with varying factors to try and provide an accurate representation of the level of interest in the product or service. For example, the touchpoints could be weighted from highest to lowest as follows: 1) a person physically touching the product or service, 2) a person looking at the product or service for a certain length of time, 3) a person looking at the product or service, 4) a person entering an exhibitor area where the product or service is displayed, and 5) a person being within a certain distance of the product or service.

One example of the weighting factors for a ranking of the type of touchpoints could be: 1) a person physically touching the product or service, weighting factor 0.9, 2) a person looking at the product or service for a certain length of time, weighting factor 0.7, 3) a person looking at the product or service, weighting factor 0.5, 4) a person entering an exhibitor area where the product or service is displayed, weighting factor 0.4, and 5) a person being within a certain distance of the product or service, weighting factor 0.3, although any other weighting factors could be used.

Using the weighting factors from the previous paragraph, embodiments of the invention could determine a weighted number of touch points for a product or service by multiplying the number of each type of touchpoint by its weighting factor and adding the results together. For example, if analysis of the sensor data determined there were the following number of touchpoints for a product or service: a person physically touching the product or service, 50 touchpoints; a person looking at the product or service for a certain length of time, 40 touchpoints; a person looking at the product or service, 30 touchpoints, a person entering an exhibitor area where the product or service is displayed, 60 touchpoints, and a person being within a certain distance of the product or service, 80 touchpoints, the weighted touchpoints would be: 50×0.9+40×0.7+30×0.5+60×0.4+80×0.3=136 weighted touchpoints and 260 unweighted touchpoints. The rankings could be based on the weighted or unweighted number of touchpoints for the product or service, and different weighting factors than discussed above could be used.

Embodiments of the invention can also provide rankings of the products and services at the convention based upon a combination of touchpoints as described above, and based on keywords that can be entered into the computer device, through an interface, such as a keyboard, voice input, or any other input. For example, if an attendee of a Consumer Electronics Convention wanted to search for the term “4K television”, the attendee could input the term to the computer device, the computer device could search a recordation of all products and services at the convention for those labeled as 4K television, and then order that listing based on the touchpoints determined for each of the 4K television products. The computer device could associate the determined touchpoints with a particular product or service in many ways, such as having a model number, name or other tag displayed near the product or service that can be determined by the computer from the sensor data. The same name, model number or other tag could be associated with the product or service in the product or service recordation such that the computer device could match the products or services found in the keyword search with the touchpoints for the product or service.

Embodiments of the invention can also provide recommendations of products or services based on a particular product or service an attendee of the convention is interested in. For example, if an attendee registers a touchpoint for a particular product as determined by embodiments of the present invention, the embodiments can also provide additional recommendations of similar products to the attendee with rankings of the recommendations based on the touchpoints and/or weighted touchpoints.

For example, a user could be provided with an identifier that allows the system to determine where the user is within the convention. The tag could be a tag such as an RFID tag, a name tag that can be recognized in the computer device by analysis of the video, a application loaded onto the attendees phone, and so forth. Then, when the user expresses interest in a particular product or service, the embodiments can search for other products or services of the same or related type, and present one or more of those same or related type of product or service to the attendee as a recommended product or service. The recommended product or service would be determined based on a search by the computer device, such as by keyword, and based on determined touchpoints of the products or services of the same or related type.

The recommended product or service could be presented to the attendee on a display of the computerized device. For example, the computerized device could be embodied as one or a plurality of kiosk-type devices located in the convention that the attendee can access to see one or more product or service recommendations tailored for that attendee. Alternatively, the recommendations could be presented to the attendee on his cellphone or other device. The recommendations could be presented automatically to the attendee, or the recommendations could be presented upon request of the attendee, such as having a display with a recommended products button the attendee can select.

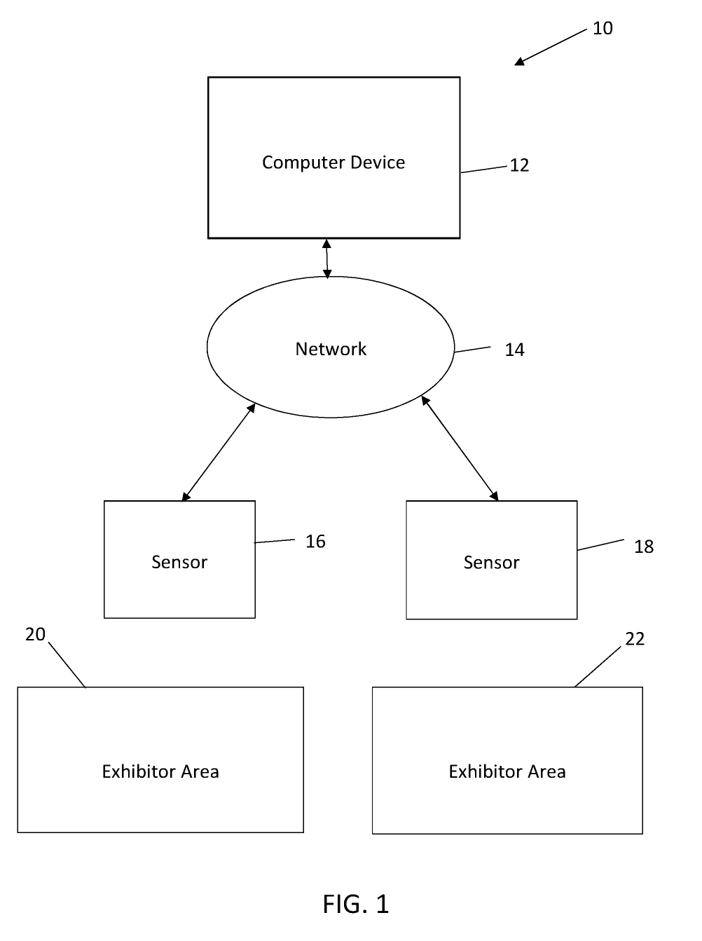

Embodiments of the invention will now be described in more detail first with reference to FIG. 1. As illustrated in FIG. 1, one embodiment of a system 10 of the invention comprises a computer device 12 that may be connected over a network 14 to one or more sensors 16, 18. The computer device includes at least one processor and a memory. The computer device 12 could be embodied as any type of computerized device, such as a desktop computer, a laptop computer, a tablet computer, a cellphone, and so forth. The computer device 12 could be a single device or a collection of computing devices. The collection of computing devices could include virtual machines, physical devices, and/or distributed devices to create a cloud-based system.

The processor of computer device 12 may be one or more processors and may be configured to execute various instructions (comprising executable software or embedded as hardware). The memory of computer device 12 may be any type of a data storage device, such as one or more forms of semi-conductor type storage device, such as ROM or RAM (such as EEPROM, PROM, etc. as are now known or later developed), and or mass storage devices such as hard drives, tape drives or the like. The memory may store the instructions to be executed by the processor.

The network 14 may be a wired or wireless network, such as a LAN or WAN, including the Internet. The sensors 16, 18 can be one or a combination of any type of sensor device that can be configured to generate data that can be resolved into touch points for the product or service. For example, the sensors could be video cameras, such as CCD, CMOS or NMOS image sensors, pressure sensors, heat sensors, proximity sensors, contact sensors, sound or vibration sensors, and so forth.

The sensors 16, 18 are configured to send sensor data to the computer device 12 over network 14. The computer device is configured to analyze the sensor data to determine touch points for the products and services, as further discussed herein

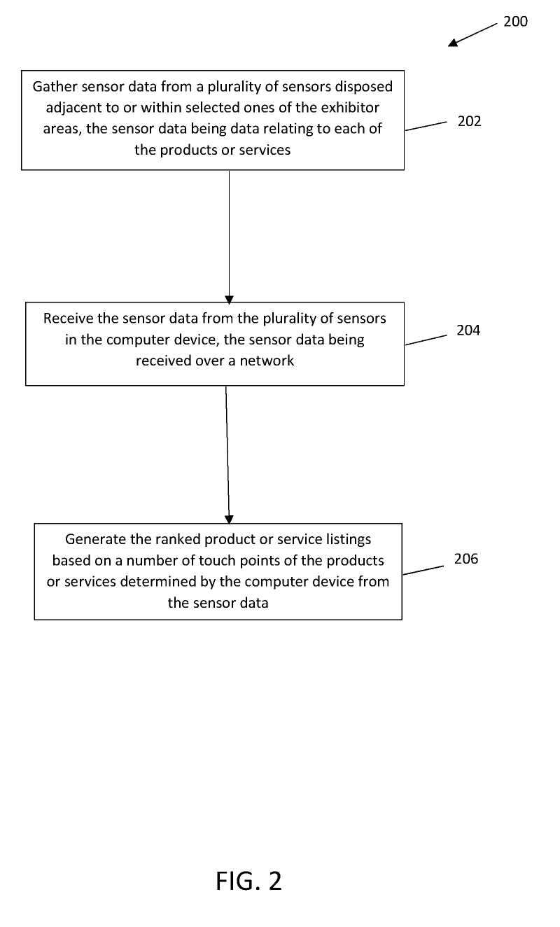

FIG. 2 illustrates a flowchart of embodiments of the present invention. A method or process 200 includes steps 202-206. In step 202, the sensors 16, 18 gather sensor data from a plurality of sensors disposed adjacent to or within selected ones of the exhibitor areas, the sensor data being data relating to each of the products or services. As previously explained, the sensors can be any type of sensor that can be used to provide data to analyze touchpoints of the products or services.

In step 204, the sensor data is received from the plurality of sensors 16, 18 in the computer device 12, the sensor data being received over a network 14.

In step 206, the ranked product or service listings are generated based on a number of touch points of the products or services determined by the computer device from the sensor data. The product or services listing may be generated based on weighted or unweighted touchpoints as explained herein.

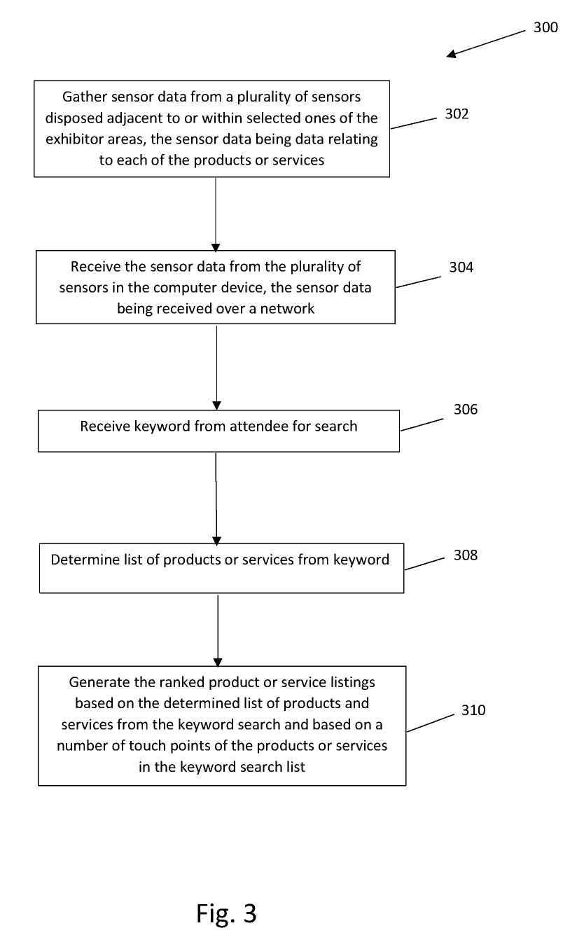

FIG. 3 is a flowchart of embodiments of the present invention. A method or process 300 includes steps 302-310. In step 302, the sensors 16, 18 gather sensor data from a plurality of sensors disposed adjacent to or within selected ones of the exhibitor areas, the sensor data being data relating to each of the products or services.

In step 304, the sensor data is received from the plurality of sensors 16, 18 in the computer device 12, the sensor data being received over a network 14. In step 306, a keyword or other search term is received from an attendee of the convention at the computer device 12.

In step 308 the computer device 12 determines a list of products or services at the convention from the keyword or other search term. This may be done by the computer device 12 comparing the keyword or other search terms to a list of products or services at the convention, that may have preassigned keywords associated with each product or service on the list, or the computerized device may search for products or services on the list by other known techniques, such as name searching, product type searching, etc, although other search methods can be used.

In step 310, the ranked product or service listing is generated by the computer device 12 based on the determined list of products and services from the keyword search and based on a number of touch points of the products or services in the keyword search list. First, the computer device 12 conducts the keyword or other phrase search against a list of products and services at the convention, which may have associated keywords for searching or other search techniques may be used. Then, the list generated by the keyword search is ranked in order based on the number of touch points of the products or services in the keyword search list.

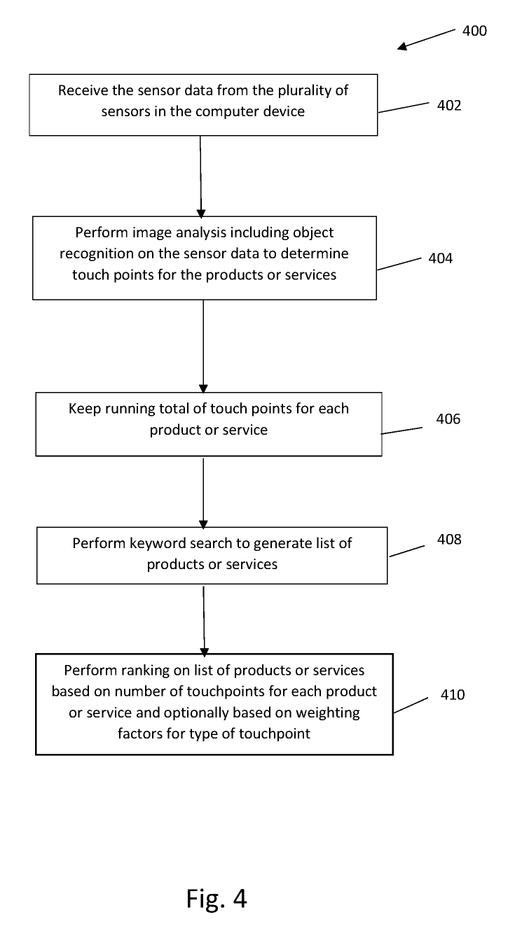

FIG. 4 illustrates a flowchart of methods of determining touchpoints from sensor data in accordance with embodiments of the invention. In step 302, the sensors 16, 18 gather sensor data from a plurality of sensors disposed adjacent to or within selected ones of the exhibitor areas, the sensor data being data relating to each of the products or services.

In step 404, the computer device 12 performs image analysis, which may include object recognition, on the sensor data to determine touch points for the products or services. The image analysis can identify the products or services in the sensor data, as well as identifying a location of a person in the sensor dat. The image analysis can also identify touch points according to predefined criteria (as described herein) for each of the products or services, and keep a running tally of the number of touch points for each product or service in step 406.

In step 408, a keyword or other term search is conducted based on an input term to generate a list of products or services concerning the term. In step 410, ranking is performed on the list generated in step 408 based on the number of touchpoints for each product or service and optionally based on weighting factors for type of touchpoint.

Embodiments of the present invention overcome various problems of how an attendee at a convention can find products or services that may be of interest. For example, attendee at a convention may be interested in hot products that are generating interest among other attendees of the convention. For example, by determining ranked lists of products or services at the convention based on touchpoints of those products or services, the embodiments can present products or services to the attendee that are generating interest among attendees of the convention. The products that are generating the most interest are located at the top of the list indicating they are generating the most interest among attendees.

Additionally, by combining the keyword or other term search with the results based on the number of touchpoints, embodiments of the present invention can provide a listing of products or services that is focused in a specific area of interest to the attendee but that is also generating high interest among other attendees at the convention. The listing can include directions to location where the products or services on the ranked list are located within the convention.

It will be understood that the above described arrangements of apparatus and the methods are merely illustrative of applications of the principles of embodiments of the invention and many other embodiments and modifications may be made without departing from the spirit and scope of the invention as defined in the claims.

What is claimed is:

1. A system for providing a ranked product or service listing for products or services at a convention, the convention including a plurality of exhibitor areas where the exhibitors display products or services, the system comprising:
a network;
a computer device including a processor and a memory, the memory storing non-transitory machine-readable code to be executed by the processor to provide the ranked product or service listings to an attendee of the convention; and
a plurality of sensors disposed adjacent to or within selected ones of the exhibitor areas, the sensors configured to gather sensor data relating to each of the products or services,
wherein the computer device is configured to generate the ranked product or service listings based on a number of touch points of the products or services determined by the computer device from the sensor data.

2. The system of claim 1, wherein the computer device determines the number of touch points of the products or services based on image analysis of the sensor data.

3. The system of claim 1, wherein the touch points for each product or service are determined by the computer device based on touch point factors including at least one of: 1) a number of times people enter an exhibit where the product or service are located, 2) a number of times a product or service are looked at by a person, 3) a number of times a product or service are touched by a person in the exhibit area, or 4) how long a person looks at the product or service.

4. The system of claim 3, wherein the touch point factors are individually weighted, and an order of the ranked product service or listing is determined by the computer device based on the number of the touch points for each product or service and based on the weighting of the touch point factors.

5. The system of claim 1, wherein the ranked product or service listing are generated based on the determined number of touch points of the products or services and based on a search term input by an attendee of the convention.

6. The system of claim 1, wherein the convention is a shopping mall and the exhibitor areas are stores within the shopping mall.

7. A system for providing a ranked product or service listing for products or services at a convention, the convention including a plurality of exhibitor areas where the exhibitors display products or services, the system comprising:
a network;
a computer device including a processor and a memory, the memory storing non-transitory machine-readable code to be executed by the processor to provide the ranked product or service listings to an attendee of the convention; and
a plurality of sensors disposed adjacent to or within selected ones of the exhibitor areas, the sensors configured to gather sensor data relating to each of the products or services,
wherein the computer device is configured to generate the ranked product or service listings based on a number of touch points of the products or services determined by the computer device from the sensor data,
wherein the touch points for each product or service are determined by the computer device based on touch point factors including at least one of: 1) a number of times people enter an exhibit where the product or service are located, 2) a number of times a product or service are looked at by a person, 3) a number of times a product or service are touched by a person in the exhibit area, or 4) how long a person looks at the product or service, and
wherein the ranked product or service listing are generated based on the determined number of touch points of the products or services and based on a search term input by an attendee of the convention.

8. The system of claim 7, wherein the computer device determines the number of touch points of the products or services based on image analysis of the sensor data.

9. The system of claim 7, wherein the touch point factors are individually weighted, and an order of the ranked product service or listing is determined by the computer device based on the number of the touch points for each product or service and based on the weighting of the touch point factors.

10. The system of claim 7, wherein the convention is a shopping mall and the exhibitor areas are stores within the shopping mall.

11. A method for providing ranked product or service listings for products or services at a convention using a computer device having a processor and a memory, the convention including a plurality of exhibitor areas where the exhibitors display products or services, the method comprising:
gathering sensor data from a plurality of sensors disposed adjacent to or within selected ones of the exhibitor areas, the sensor data being data relating to each of the products or services;
receiving the sensor data from the plurality of sensors in the computer device, the sensor data being received over a network; and
generating the ranked product or service listings based on a number of touch points of the products or services determined by the computer device from the sensor data.

12. The method of claim 11, further comprising determining the number of touch points of the products or services based on image analysis of the sensor data.

13. The method of claim 11, further comprising determining the number of touch points for each product or service based on touch point factors including at least one of: 1) a number of times people enter an exhibit where the product or service are located, 2) a number of times a product or service are looked at by a person, 3) a number of times a product or service are touched by a person in the exhibit area, or 4) how long a person looks at the product or service.

14. The method of claim 13, wherein the touch point factors are individually weighted, and an order of the ranked product service or listing is determined by the computer device based on the number of the touch points for each product or service and based on the weighting of the touch point factors.

15. The method of claim 14, further wherein generating the ranked product or service listing generating the ranked product or service listing based on the determined number of touch points of the products or services and based on a search term input by an attendee of the convention.

16. The method of claim 11, wherein the convention is a shopping mall and the exhibitor areas are stores within the shopping mall.
